(19) United States
(12) Patent Application Publication
(10) Pub. No.: US 2009/0116745 A1
(43) Pub. Date: May 7, 2009

(54) INPUT PROCESSING DEVICE

(75) Inventors: Toshio KAWANO, Fukushima-ken (JP); Yoshiyuki KIKUCHI, Fukushima-ken (JP); Kazuhito OHSHITA, Fukushima-ken (JP); Shoji SUZUKI, Fukushima-ken (JP); Kenji WATANABE, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/264,475

(22) Filed: Nov. 4, 2008

(30) Foreign Application Priority Data
Nov. 5, 2007 (JP) 2007-287573

(51) Int. Cl. G06K 9/62; G06F 3/041

(52) U.S. Cl. 382/189; 345/173

(57) ABSTRACT

An input processing device includes an input member having an input pad and a detecting section that detects a position where an indicator touches the input pad and a processing section that inputs a character or a figure on the basis of an input signal obtained from the input member, a document tool board and a handwriting tool board are displayed on a display screen and an input locus display region where a locus drawn with the input pad is displayed and a character display region where a character or a symbol recognized from the locus is displayed are displayed when a document tool and a handwriting tool are started by a processing operation of the processing section, and the character or the symbol displayed in the character display region is transferred to the document tool by a predetermined operation.

### CROSS REFERENCE TO RELATED APPLICATIONS

The present application contains subject matter related to and claims the benefit of Japanese Patent Application JP2007-287573 filed in the Japanese Patent Office on Nov. 05, 2007, the entire contents of which is incorporated herein by reference.

### BACKGROUND OF THE DISCLOSURE

1. Technical Field

The present invention relates to an input processing device that inputs a character string to a document tool by inputting a character or a symbol in handwriting using a flat input pad.

2. Related Art

A keyboard or a mouse may be used as an operation input member provided in a personal computer. For example, a notebook type personal computer may include a flat input member having an input pad together with the keyboard. The flat input member can detect a change in capacitance between electrodes when an indicator having a low electric potential, such as a human finger, approaches or touches the input pad. Coordinate data can be obtained by the change in capacitance, and the same control signal as when a mouse, which is an external device, is operated is generated on the basis of the coordinate data obtained from the input member in a control unit of the personal computer. In recent years, a personal computer in which coordinate data is input by operating a tablet input device, which is provided to overlap a display screen, with a pen has also appeared.

As disclosed in Japanese Unexamined Patent Application Publication Nos. 2001-92593, 2001-195164, and 2002-23938, various input tools capable of writing a character or a symbol in handwriting may be used as application software of a personal computer. When the input tool starts, an input region of the input tool may be displayed on a display screen.

A cursor may be moved into the input region by using a mouse or an input pad of a flat input member or using a tablet input device. Also, a character or a symbol may be drawn in the input region by moving the mouse while pressing a button of the mouse to thereby move the cursor in the input region. Alternatively, a character or a symbol may also be drawn by operating the input pad or the tablet input device with a finger or a pen in order to move the cursor in the input region.

In an operation of inputting a character or a symbol using a known input tool, however, a locus drawn on a screen of an input tool using a mouse, an input pad, or a tablet is displayed by a single character and one character recognized from the locus is input to a document tool. In this method, it is difficult to recognize or change the handwritten character or symbol on the input tool for handwriting because both the handwritten locus and the character recognized from the locus cannot be displayed on the input tool. Furthermore, at a point of time when characters input by the input tool for handwriting are transferred to the document tool, the characters are fixed. For this reason, an operation of selecting a right character while performing a handwriting input or an operation of drawing a plurality of characters in handwriting, and converting the character string into a phrase including corresponding Chinese characters, and then transferring the phrase to the document tool cannot be performed.

That is, although known input tools are suitable for drawing only one Chinese character or the like to be input, it is difficult to perform continuous writing operations, such as an operation of inputting a plurality of characters continuously by handwriting or an operation of inputting Hiragana to the input tool, converting the character string into Chinese characters, and transferring the converted Chinese characters to the document tool.

These and other drawbacks exist.

### SUMMARY OF THE DISCLOSURE

An advantage of some aspects of embodiments of the invention is that they provide an input processing device capable of easily inputting a character string using an input tool for handwriting and of inputting a character string converted into Chinese characters and the like after handwriting.

According to various exemplary embodiments, there is provided an input processing device that may include an input member having an input pad and a detecting section that detects a position where an indicator touches the input pad; and a processing section that inputs a character or a figure on the basis of an input signal obtained from the input member. When a document tool and a handwriting tool are started by a processing operation of the processing section, a document tool board and a handwriting tool board may be displayed on a display screen and an input locus display region where a locus drawn with the input pad is displayed and a character display region where a character or a symbol recognized from the locus is displayed may be displayed, and the character or the symbol displayed in the character display region may be transferred to the document tool by a predetermined operation.

In the input processing devices according to various exemplary embodiments, when a character or a symbol is handwritten with the input pad, the locus may be displayed on the handwriting tool board and a character recognized from the locus may be displayed. This character may be displayed as a printing type of a predetermined font. Accordingly, since a character handwritten and recognized can be checked before the character is transferred from the handwriting tool board to the document tool, modification, deletion, and the like can be easily performed when a wrong character is written. As a result, it may be possible to write a right character string by transferring characters to the document tool in a sequential manner.

For example, in an input processing device according to an exemplary embodiment, a plurality of recognized characters may be displayed in a sequential manner as a character string in the character display region.

When a plurality of characters handwritten and recognized are sequentially displayed in the character display region of the handwriting tool board, it is possible to decide and complete a phrase or a short sentence at a point of time when the characters are handwritten on the handwriting tool board and then transfer the completed phrase or short sentence to the document tool.

Furthermore, in an input processing device according to an exemplary embodiment, an indicator display indicating an input place of a character may be made in the character display region. When a character or a symbol is drawn with the input pad and a predetermined operation is performed, the character or the symbol recognized from the locus drawn with the input pad may be displayed in the place where the indicator display is shown and the indicator display may move by one character within the character display region to wait for input of a next character.

In various exemplary embodiments, when characters or symbols are drawn one by one in handwriting using the input pad, the characters recognized from the locus may be written sequentially on the handwriting tool board. Therefore, it may be possible to write a short sentence correctly on the handwriting tool board and then transfer the sentence to the document tool.

Furthermore, in an input processing device according to an exemplary embodiment, any of the plurality of characters displayed in the character display region may be deleted, or a character may be inserted within a character string displayed in the character display region.

Furthermore, in an input processing device according to an exemplary embodiment, when processing for converting the character displayed in the character display region is performed, a plurality of conversion candidates may be displayed on the handwriting tool board and a character selected may be displayed in the character display region when one of the conversion candidates is selected.

Thus, since conversion to Chinese characters or conversion to a right word or phrase can be performed on the handwriting tool board, a sentence can be completed at a point of time when a character string is transferred to the document tool.

Furthermore, in an input processing device according to an exemplary embodiment, when the character displayed in the character display region of the handwriting tool board is transferred to the document tool board, the character display region may become blank so that a next character may be input.

Furthermore, in an input processing device according to an exemplary embodiment, the document tool and the handwriting tool may be executed by software installed in a control unit of a personal computer.

According to the various embodiments, a character written by hand can be transferred as a correct character string using an input pad. For example, it may be possible to continuously write a plurality of characters by hand, convert the characters into Chinese characters or a phrase, and then transfer the Chinese characters or the phrase converted to a document tool.

### BRIEF DESCRIPTION OF THE DRAWINGS

FIG. 1 is a perspective view showing a personal computer including an input processing device according to an exemplary embodiment;

FIG. 2 is plan view showing a flat input member according to an exemplary embodiment;

FIG. 3 is a view showing a circuit block of an input processing device according to an exemplary embodiment;

FIGS. 4A and 4B are explanatory views showing a display example of a handwriting tool board according to an exemplary embodiment;

FIG. 5 is an explanatory view showing a display example of a handwriting tool board according to an exemplary embodiment;

FIG. 6 is an explanatory view showing a display example of a handwriting tool board according to an exemplary embodiment; and

FIG. 7 is an explanatory view showing a display example of a handwriting tool board according to an exemplary embodiment.

### DESCRIPTION OF EXEMPLARY EMBODIMENTS

The following description is intended to convey a thorough understanding of the embodiments described by providing a number of specific embodiments and details involving input processing devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

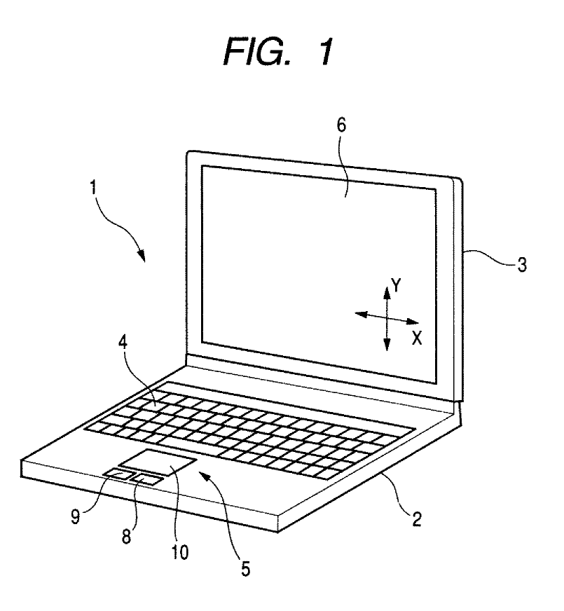

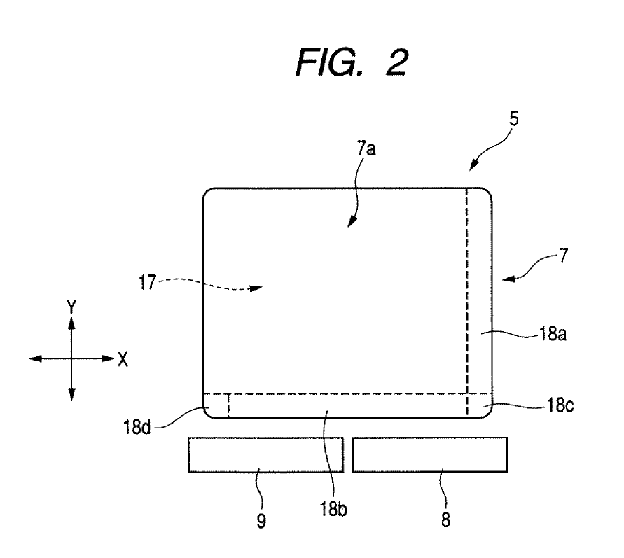

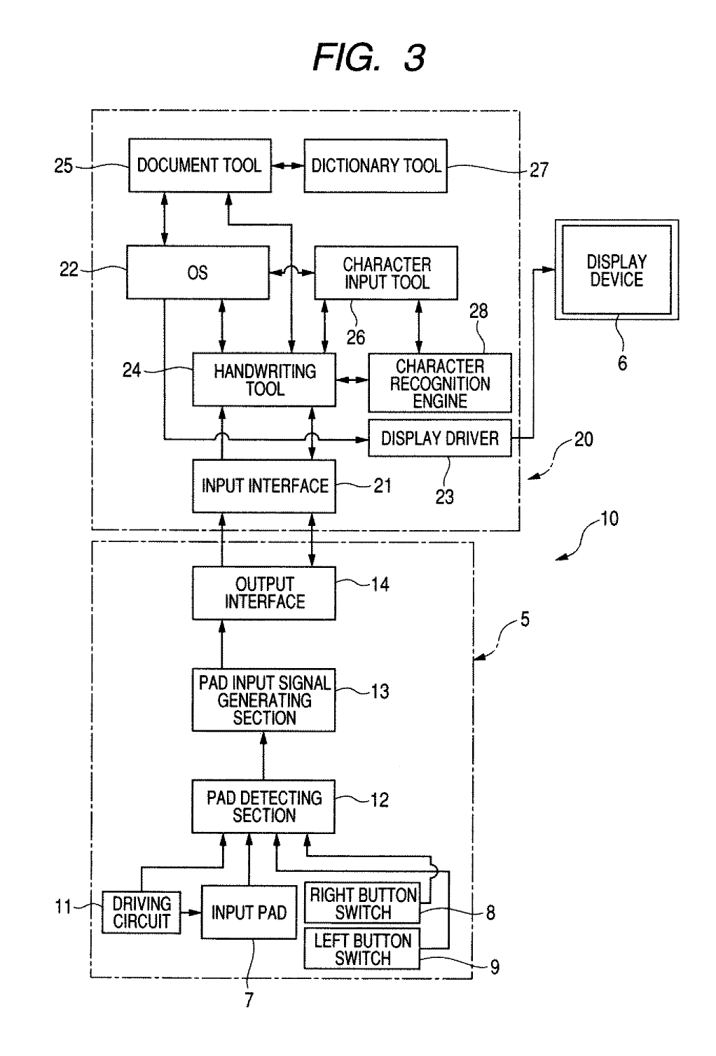

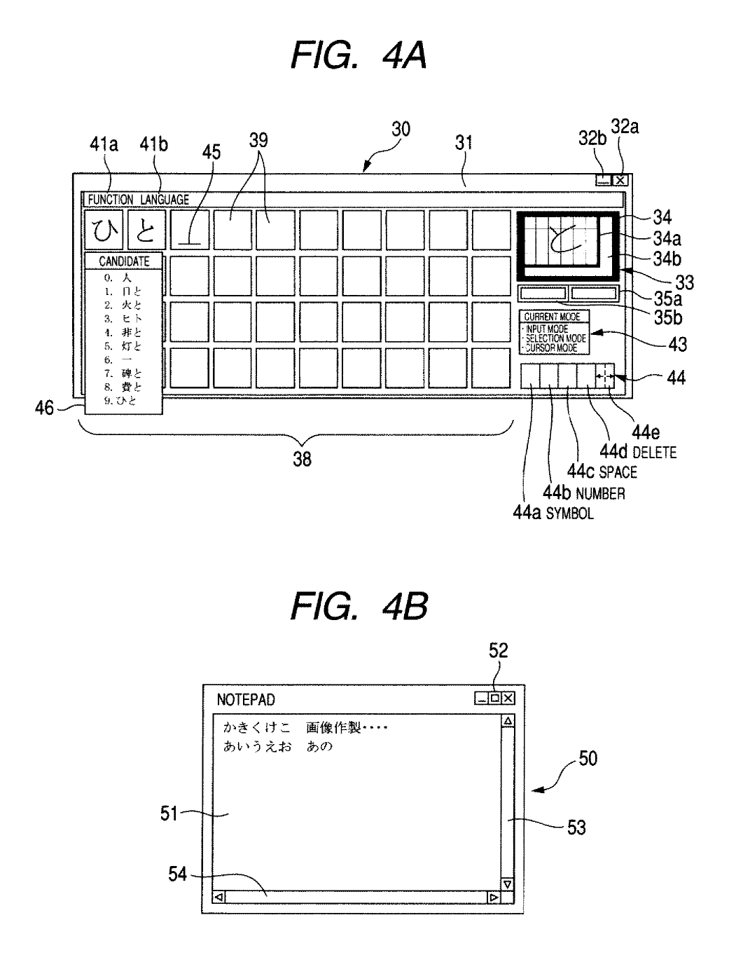

FIG. 1 is a perspective view showing a notebook type personal computer in which an input processing device according to an exemplary embodiment is provided, and FIG. 2 is a plan view showing a flat input member according to an exemplary embodiment. FIG. 3 is a view showing a circuit block of an input processing device according to an exemplary embodiment. FIGS. 4A, 4B, 5, 6, and 7 are views explaining an operation of input processing devices according to various exemplary embodiments.

In a personal computer 1 shown in FIG. 1, a main body 2 and a lid portion 3 may be connected together so as to be able to be folded. A keyboard device 4 and a flat input member 5 may be provided in a console panel of a top surface of the main body 2. A display device 6 formed of a liquid crystal display panel may be provided on a front surface of the lid portion 3.

As shown in the enlarged view of FIG. 2, the flat input member 5 may have an input pad 7, a right button 8 located at a lower right side of the input pad 7, and a left button 9 located at a lower left side of the input pad 7.

The input pad 7 may have a flat input screen 7a. The input pad 7 may have a plurality of X electrodes extending in the X direction and a plurality of Y electrodes extending in the Y direction which may face each other with an insulating layer interposed therebetween and may have a detection electrode provided between the adjacent X electrodes. A thin insulating sheet may be provided on surfaces of the electrodes, and a surface of the insulating sheet may be the input screen 7a.

As shown in FIG. 3, a predetermined voltage may be sequentially applied to the X electrodes and a predetermined voltage may be sequentially applied to the Y electrodes at different timing by a driving circuit 11 provided in the input member 5. Since a capacitance may be formed between a finger, which is a conductive indicator having an almost ground potential, and each electrode when the finger touches the input screen 7a, the capacitance between a detection electrode and an X electrode may change in a portion which the finger approaches and the capacitance between the detection electrode and a Y electrode changes.

If the indicator touches the input screen 7a when a pulse shaped voltage is applied to the X electrode or Y electrode, a voltage between the X electrode and the detection electrode and a voltage between the Y electrode and the detection electrode may change with the change in capacitance. The voltage change may be detected through the detection electrode in a pad detecting section 12. When the voltage change is detected through the detection electrode in the pad detecting section 12, a location which the finger touches on the input screen 7a can be detected on X-Y coordinates by acquiring timing information on which X electrode or Y electrode is applied with the voltage.

Accordingly, when a finger touching the input screen 7a moves, the movement locus of the finger may be detected on the X-Y coordinates. In addition, since the capacitance between electrodes changes for a short time when a so-called tapping operation of making a finger approach the input screen 7a quickly and apart from the input screen 7a quickly is performed, this can be detected in the pad detecting section 12.

FIG. 3 is a block diagram showing an input processing device 10 provided in the personal computer 1.

As described above, the driving circuit 11 which may apply a pulse shaped voltage to the X electrodes and Y electrodes of the input pad 7 in a sequential manner and the pad detecting section 12 which may detect a change in a rising edge of a voltage of a detection electrode provided in the input pad 7 may be provided in the flat input member 5. By the pad detecting section 12, the contact position of a finger on the input screen 7a can be specified on the X-Y coordinates. In addition, operation signals (click signals) of the right button 8 and the left button 9 also may be detected by the pad detecting section 12.

A pad input signal generating section 13 may be provided in the input member 5. X-Y coordinate information which may be an operation signal of the input pad 7 detected by the pad detecting section 12, click information of the right button 8, and click information of the left button 9 may be generated as format data with predetermined bytes in the pad input signal generating section 13 and may be output from an output interface 14. The operation signal output from the output interface 14 may be transmitted to an input interface 21 provided in a control unit 20 of the personal computer. The output interface 14 and the input interface 21 may be USB interfaces, for example. Other similar suitable interfaces, including bluetooth, for example, may be used.

Various kinds of software may be installed in the control unit 20 of the personal computer 1. An operating system (OS) 22 also may be installed in the control unit 20. The operating system 22 may control a display driver 23 to display various kinds of information on the display device 6.

A handwriting tool 24 may be installed as software in the control unit 20, and the operation signal received in the input interface 21 may be transmitted to the handwriting tool 24. As shown in FIG. 4A, the handwriting tool 24 may display a handwriting tool board 30 on a screen, may input a character string on the basis of an operation signal with a predetermined format transmitted from the pad input signal generating section 13, and may display a character string on the handwriting tool board 30. In addition, coordinate data from the handwriting tool 24 may be sent to a document tool 25 and a character input tool 26.

The handwriting tool 24 also may have a function as an input pad driver which may generate a coordinate data signal equivalent to an operation signal of a mouse, which may be an external device, and may notify the operating system 22. Due to the function, when coordinate data is notified to the operating system 22, a cursor displayed on the screen can be moved on the basis of an operation of the input pad 7.

The document tool 25 may be installed as software in the control unit 20. The document tool 25 may have a function of a ‘notepad’ shown in FIG. 4B or other word processors, such as, e.g., Microsoft Word from Microsoft Corp. in Redmond, Wash., USA, and characters may be sequentially input by an input from the keyboard device 4. In addition, the input characters may be displayed on the document tool board 50 shown in FIG. 4B. A dictionary tool 27 also may be installed as software in the control unit 20. A kana character string input to the document tool 25, for example, maybe converted into Chinese characters, a phrase, and the like by using the dictionary tool 27.

The character input tool 26 maybe installed as software. In the control unit 20, a character recognition engine 28 may be installed as software together with the character input tool 26. The character input tool 26 and the character recognition engine 28 may have a function of recognizing a character from the locus input by handwriting. For example, Windows Vista (registered trademark) of Microsoft Corp. Redmond, Va. USA, may include the character input tool 26 and the character recognition engine 28 as standard tools. When a tablet input device is provided in the display device 6, a handwritten character may be input to the character input tool 26 by using the tablet input device. The input character may be notified to the document tool 25 and may be transferred to the ‘notepad’ or the like.

However, in the case of the character input tool 26, characters need to be written directly and sequentially one by one within a character input region displayed by the character input tool 26 by using a tablet input device, and it is difficult to input a long sentence. Moreover, in the case of the character input tool 26, a character may be written by using a mouse. In this case, however, it may be necessary to write one character in handwriting within a character input region, move a cursor to the next column with the mouse, and draw a character with the mouse while pressing a button of the mouse at the position. In addition, it takes time to input a plurality of characters and an operation is complicated.

In the input processing device 10 shown in FIG. 3, a plurality of characters or symbols may be input easily in handwriting by starting the handwriting tool 24 provided separately from the character input tool 26 and operating the input pad 7. When the handwriting tool 24 is started, the character recognition engine 2S8 shared with the character input tool 26 may be used and the dictionary tool 27 used in the character input tool 26 and the document tool 25 also may be used in common in the handwriting tool 24.

As shown in FIGS. 4A and 4B, on the display screen of the display device 6, the document tool board 50 may be displayed by the document tool 25 and the handwriting tool board 30 may be displayed by the handwriting tool 24.

The handwriting tool board 30 shown in FIG. 4A may be displayed on the screen of the display device 6 by execution of application software of the handwriting tool 24, the character recognition engine 28, and the dictionary tool 27 shown in FIG. 3.

As shown in FIG. 4A, a character or a symbol may be written on the handwriting tool board 30 using the input pad 7.

On the handwriting tool board 30, a close button 32a and a minimize button 32b are provided on a horizontally long frame display 31. An input portion model 33 may be displayed at a right end portion of the handwriting tool board 30. The input portion model 33 has a pad model 34, a right button model 35a, and a left button model 35b. The pad model 34, the right button model 35a, and the left button model 35b are display patterns which imitate the input pad 7, the right button 8, and the left button 9 shown in FIG. 2, respectively. A part of the pad model 34 may be an input locus display region 34a.

On the handwriting tool board 30, a left wide region of the input portion model 33 may include a character display region 38. A plurality of input boxes 39 may be displayed on the character display region 38. When a handwriting input mode is set, the locus input to the input screen 7a of the input pad 7 may be displayed in the input locus display region 34a, a character or a symbol recognized by the locus may input one by one in the input boxes 39, and the character is displayed as a printing type of a predetermined font. A character or a symbol first may be input into the input box 39 located at a leftmost end of an uppermost column and then the input box 39 to which a character or a symbol is input sequentially moves rightward. After characters or symbols are input into all of the input boxes 39 of the uppermost end, a character or a symbol may be input sequentially from the input box 39 which may be located at a second column from above and a leftmost end.

A function tool bar 41a and a language selection tool bar 41b may be provided at an upper left end of the frame display 31. Function selection may be made by moving a cursor to the function tool bar 41a after setting a cursor mode. A ‘character input mode’, an ‘end mode’, and the like may be displayed as a submenu when the function tool bar 41a is clicked. An operation of writing a character by hand may be started by tapping the cursor in a state where the cursor is located at the ‘character input mode’. In addition, the operation of the handwriting tool 24 may be ended, for example, by an operation of tapping the input screen 7a of the input pad 7 in a state where the cursor is located at the ‘end mode’.

By moving the cursor to the language selection tool bar 41b and tapping the input pad 7, a language of a character to be recognized in the character recognition engine 28 may be selected when writing the character by hand using the input pad 7. These languages are ‘Japanese’, ‘English’, ‘Korean’, ‘German’, ‘French’, and the like.

As shown in FIG. 4A, an auxiliary function panel 44 may be displayed on the handwriting tool board 30. The auxiliary function panel 44 may include a symbol input indicator 44a, a number input indicator 44b, a space insert indicator 44c, a delete indicator 44d, and a movement indicator 44e. When the ‘cursor mode’ is set and the cursor is tapped in a state where the cursor is located at the symbol input indicator 44a or the number input indicator 44b, a table of symbols or numbers may be displayed in a region below the handwriting tool board 30 such that any one of those can be selected. The selected symbol or number may be written in the input box 39.

A space can be inserted in the middle of a character string by moving an indicator display bar 45 shown in FIG. 4A to any position in the character string written in the character display region 38, moving the cursor to the space insert indicator 44c, and performing tapping. Furthermore, by performing tapping in a state where the cursor is located at the delete indicator 44d, a character in the input box 39 at which the indicator display bar 45 is located can be deleted. Moreover, by performing tapping in a state where the cursor is located at the movement indicator 44e, it may be possible to move the indicator display bar 45 to the right input box 39 or the left input box 39.

As shown in FIG. 2, it may be possible to divide the input screen 7a of the input pad 7 into a plurality of regions beforehand and to assign various operation functions to the regions. The number of regions divided or the sizes of regions and which function is to be assigned may be set and changed by using a set menu of a control panel.

In the example shown in FIG. 2, a large writing region 17 may be set in the middle of the input screen 7a of the input pad 7. By moving a finger in a state touching the writing region 17, the handwritten locus can be written in the input locus display region 34a shown in FIG. 4A.

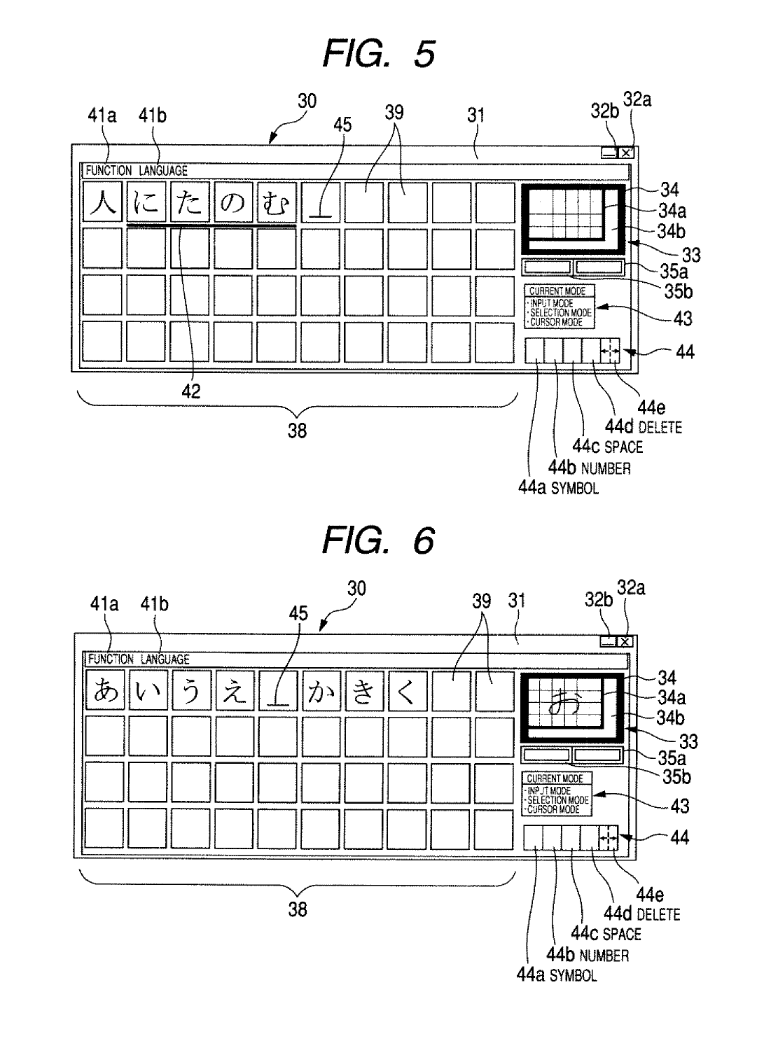

A vertical scroll region 18a which is long in a vertical direction may be provided at a right portion of the input screen 7a of the input pad 7. If a finger touches the vertical scroll region 1a and slides in the vertical direction (Y direction) when the input mode is set, a candidate menu 46 may be displayed and conversion candidate characters listed in the candidate menu 46 may be highlighted in a sequential manner as shown in FIG. 4A. For example, the conversion candidate characters may be ‘Chinese characters’, a ‘phrase’, and a combination of ‘Chinese character’ and ‘OKURIGANA’ (conjugational ending in kana added to a Chinese character) converted from a kana character string in a range designated by the selection bar 42 shown in FIG. 5. In the example shown in FIG. 4A, [symbol] of a conversion candidate character may be selected by moving a finger within the vertical scroll region 18a and a kana character string of [symbol] may be converted into the Chinese character [symbol] by tapping the input screen 7a, such that the Chinese character [symbol] can be displayed in the input box 39.

A horizontal scroll region 18b may be partitioned at a front edge portion of the input screen 7a shown in FIG. 2. In the case when a plurality of candidate menus 46 shown in FIG. 4A are displayed in a line, one of the candidate menus 46 may be selected by touching the horizontal scroll region 1b with a finger and moving the finger right and left. After one of the candidate menus 46 is selected, a Chinese character and the like further may be selected in the selected candidate menu 46 by touching the vertical scroll region 18a with a finger and sliding the finger in the vertical direction (Y direction), for example. In addition, while moving a finger touching the horizontal scroll region 18b right and left, the selected candidate menu may be displayed in a different color from other candidate menus in order to make it clear which candidate menu 46 is used.

A front corner of a right side of the input screen 7a shown in FIG. 2 is partitioned as a lower right corner region 18c. When the lower right corner region 18c is tapped with a finger, the indicator display bar 45 shown in FIG. 4A may be moved to the right input box 39 so that the input box 39 to be written with a character can move rightward. A front corner of a left side of the input screen 7a may be partitioned as a lower left corner region 18d. When the lower left corner region 18d is tapped with a finger, the indicator display bar 45 can be moved to the left input box 39.

Furthermore, a function as a ‘mode switching button’ may be assigned to the right button 8. Function switching may be performed by pressing the right button B. Whenever the right button 8 is pressed, switching in the order of ‘character input mode’→‘cursor mode’→‘character input mode’ can be made.

The ‘character input mode’ maybe a mode in which a finger may touch the input screen 7a of the input pad 7 and move to write the locus by hand. In this case, the input locus display region 34a in the pad model 34 may be displayed in a different color from the other regions and a target display of a cursor or a dot may be displayed within the input locus display 34a. At this time, if a finger moves on the input pad 7, the target display may move similarly such that the locus may be written within the input locus display region 34a. In case where the ‘character input mode’ is set, when a finger touching the input screen 7a moves, display of the cursor or dot may move only within the input locus display region 34a and the cursor may not move outside the input locus display region 34a.

The cursor mode may be a mode in which a cursor displayed on the display screen can move freely without being limited to the input locus display region 34a when the input pad 7 is operated. In the cursor model, it may be possible to move the cursor to an operation position, such as the function tool bar 41a or the language selection tool bar 41b, by operating the input pad 7.

As shown in FIG. 4A, on the handwriting tool board 30, a mode display section 43 may be provided below the input portion model 33 and one of ‘character input mode’, ‘character selection mode’, and ‘cursor mode’ may be highlighted and displayed as a current input mode. Furthermore, the ‘character selection mode’ may be a mode when the candidate menu 46 is displayed within the handwriting tool board 30 as shown in FIG. 4A and one of conversion candidate characters is selected.

A function as an ‘insert button’ may be assigned to the left button 9 shown in FIG. 2. When the left button 9 is pressed, a character string displayed in the character display region 38 of the handwriting tool board 30 shown in FIG. 4A may be transferred to the document tool board 50.

The document tool board 50 shown in FIG. 4B may include a display region 51, and the character string displayed in the character display region 38 of the handwriting tool board 30 may be transferred to the display region 51. The character string may be displayed as a font in the display region 51.

As shown in FIG. 4B, a button display 52 indicating ‘minimize’, ‘maximize’, and ‘close’ for frame display, a vertical scroll bar display 53, and a horizontal scroll bar display 54 may be provided on the document tool board 50. When the handwriting tool 24 starts and the handwriting tool board 30 shown in FIG. 4A is displayed on the screen of the display device 6, the cursor may be moved to the location matching the button display 52, the vertical direction scroll bar display 53, or the horizontal scroll bar display 54 by operating the input pad 7 after setting the ‘cursor mode’. The button display 52 can be moved by performing tapping at the position of the finger, and a vertical scroll operation or a horizontal scroll operation can be performed by moving the finger by tapping.

Next, an operation of inputting a sentence by a handwriting operation using the input pad 7 after starting the handwriting tool 24 and the document tool 25 will be described.

When the handwriting tool 24 starts, the handwriting tool 24 may be set to the ‘character input mode’. In addition, the right button 8 or the like may be pressed to set the ‘character input mode’ from the other modes.

When the ‘character input mode’ is set, the indicator display bar 45 may blink on a lower side of the input box 39 within the input box 39 to be input with a character. Immediately after starting the handwriting tool 24, all of the input boxes 39 may be blank and the indicator display bar 45 may blink within the input box 39 located at a leftmost portion of an uppermost column.

When the ‘character input mode’ is set, the input locus display region 34a shown in FIG. 4A may be displayed in a different color from the other regions. In addition, a cursor may have moved into the input locus display region 34a and a target display, such as a dot, may be displayed in the input locus display region 34a. In the ‘character input mode’, a movement region of the cursor displayed on the display screen maybe restricted, and the cursor may not move outside the input locus display region 34a when the input pad 7 is operated.

When a finger touches the writing region 17 of the input pad 7 and moves while the ‘character input mode’ is set, the movement state of the finger may be detected in the pad detecting section 12 and a pad input signal with a predetermined format may be generated in the pad input signal generating section 13 and then may be sent to the handwriting tool 24. In addition, as shown in FIG. 4A, the locus following the movement of the finger may be displayed in the input locus display region 34a of the handwriting tool board 30. Moreover, when moving the finger touching the writing region 17, the locus following the movement of the finger can be displayed within the input locus display region 34a only by moving the finger without performing the other operations, that is, an operation of pressing the right button 8 or an operation of pressing the left button 9.

The indicator display bar 45 may move to the right adjacent input box 39 by tapping the lower right corner region 18c of the input screen 7a of the input pad 7 shown in FIG. 2 with the finger when it is determined that the locus of a predetermined character has been written by hand.

By this operation, it may be determined that the input operation of one character has been completed. Then, in the handwriting tool 24, the character recognition engine 28 may be operated to recognize a character closest to the locus drawn in the input locus display region 34a, and the recognized character may be input into the input box 39 located at the leftmost portion of the uppermost column. The character input into the input box 39 may be a printing type character of a predetermined font. In FIGS. 4A and 4B, a case in which the language is set as Japanese is shown. It may be determined that a character drawn first is [symbol] of Hiragana, the character [symbol] may be input into the input box 39 located at the leftmost portion of the uppermost column, and the printing type may be displayed on the basis of the font. Furthermore, when it is determined that a ‘Chinese character’ has been input to the input locus display region 34a by an operation of the input pad 7, the ‘Chinese character’ recognized in the character recognition engine 28 may be input into the input box 39 where the indicator display bar 45 is located at that time, and the printing type may be displayed on the basis of the font.

In addition, when the indicator display bar 45 has moved rightward, only one character ( [symbol] in the above example) determined to be closest to the character of the locus drawn in handwriting within the input locus display region 34a as described above may be determined and the character may be immediately displayed in a print font within the input box 39. Also, a plurality of candidate characters similar to the character of the locus drawn in handwriting within the input locus display region 34a may be displayed so that one of the candidate characters may be selected. In this case, when the indicator display bar 45 has moved rightward, a plurality of characters similar to the character of the locus drawn within the input locus display region 34a may be displayed in a candidate list, such that one of the characters may be designated and selected as needed. The candidate at this time may be a character whose locus or writing order is similar, such as [symbol] [symbol] [symbol] and [symbol] when [symbol] of Hiragana is drawn in the input locus display region 34a, for example.

While these characters are being displayed, one of the candidate characters may be selected by sliding the vertical scroll region 18a shown in FIG. 2 by hand and selecting one tapping one of the characters. In this case, if the list display of the candidate list is disregarded and an operation of inputting a character into the next input box 39 where the indicator display bar 45 blinks is performed, the candidate automatically may disappear and a first candidate character may be displayed on the input box 39 therebefore.

While the indicator display bar 45 is blinking in the second input box 39 from the left of the uppermost column, a character may be input into the second input box 39 by operating the writing region 17 of the input screen 7a of the input pad 7 with a finger, writing the locus in the input locus display region 34a, and tapping the lower right corner region 18c of the input screen 7a. In the example of FIG. 4A, [symbol] of Hiragana may be input into the second input box 39. The selection bar 42 shown in FIG. 5 may extend rightward under the input box 39 into which characters are input. As shown in FIG. 4A, when [symbol] and [symbol] are input, the selection bar 42 may be displayed under the two characters.

In order to convert the two characters into Chinese characters after inputting [symbol] and [symbol] of Hiragana, the finger may be made to touch the vertical scroll region 18a of the input screen 7a of the input pad 7 shown in FIG. 2 and slide in the vertical direction (Y direction). Then, as shown in FIG. 4A, the candidate menu 46 may appear in the character display region 38. At the same time, a vertically long region 34b on the right side of the input portion model 33 within the handwriting tool board 30 may be colored and displayed in a different color from other regions. When the finger slides on the vertical scroll region 18a of the input screen 7a in the vertical direction, conversion candidate characters in the candidate menu 46 may be highlighted in a sequential manner along the direction. When the finger taps within the vertical scroll region 18a or taps one place of the input screen 7a while one of the conversion candidate characters may be highlighted, the converted character may be displayed in the input box 39.

In the examples shown in FIGS. 4A and 5, the two characters of [symbol] and [symbol] may be converted into [symbol] which is one Chinese character, and [symbol] that is a Chinese character may be displayed in the input box 39 located at the leftmost portion of the uppermost column. At the same time, the indicator display bar 45 may move to the adjacent left input box 39 and blinks within the blank input box 39 adjacent to the right side of the input box 39 where the character of [symbol] may be displayed.

Then, when the finger moves within the writing region 17 of the input pad 7 in the input standby mode in which the indicator display bar 45 blinks, the locus of a next character may be displayed on the input locus display region 34a. Then, when the lower right corner region 18c is tapped, a character recognized from the locus may be displayed in the input box 39 and the blinking indicator display bar 45 may move to the adjacent right blank input box 39. A plurality of characters may be input by repeating those described above. In the example shown in FIG. 5, [symbol] may be input after [symbol] . In addition, the selection bar 42 may extend under the four characters. At this time, when the finger moves up and down on the vertical scroll region 18a shown in FIG. 2, the candidate menu 46 may be displayed. For example, a phrase when [symbol] has been converted into [symbol] may exist within the candidate menu 46. When the phrase is selected and determined by tapping, characters of [symbol] may be input next to [symbol] within the character display region 38.

When the left button 9 shown in FIG. 2 is pressed at a point of time at which a predetermined number of characters, such as [symbol] may be input in the character display region of the handwriting tool board 30, a character data code of ‘ [symbol] held in the handwriting tool 24 shown in FIG. 3 may be transmitted to the document tool 25 and a character string [symbol] may be transferred into the display region 51 of the document tool board 50 shown in FIG. 4B.

Furthermore, in order to delete one of the characters written in the character display region 38 of the handwriting tool board 30, the lower left corner region 18d of the input screen 7a shown in FIG. 2 maybe tapped and the indicator display bar 45 may be made to move to the left input box 39. By one tapping, the indicator display bar 45 may move to the one left input box 39. By this operation, the indicator display bar 45 may be moved under a character that needs to be deleted. In addition, by pressing the ‘Delete’ key of the keyboard device 4 while touching the lower left corner region 18d shown in FIG. 2 with the finger, a character of the input box 39 in which the indicator display bar 45 is located can be deleted. After the character is deleted, a character displayed in the right input box 39 may move leftward by one character, such that characters located before and after the deleted character are automatically packed.

In addition, a character may also be deleted by moving the indicator display bar 45 under the character which needs to be deleted, setting the ‘cursor mode’ by clicking the right button 8, and tapping the input pad 7 in a state where a cursor displayed on the screen is located at the delete indicator 44d of the auxiliary function panel 44 displayed on the handwriting tool board 30 by operating the input pad 7.

Then, in case of inserting a space or a character between the characters input to the character display region 38, the lower left corner region 18d of the input pad may be tapped and the indicator display bar 45 may be moved to the input box 39 in which the space or the character is to be inserted. In addition, by pressing the space key of the keyboard device 4 in a state where the finger touches the lower left corner region 18d, the input box 39 in which the indicator display bar 45 is located may become blank and the character displayed in the input box 39 and characters written in the input boxes 39 on the right side thereof may sequentially move to right input boxes by one single character, as shown in FIG. 6.

As shown in FIG. 6, when the finger touches the writing region 17 of the input screen 7a of the input pad 7 to draw a character while the indicator display bar 45 is blinking in the blank input box 39, the locus may be written in the input locus display region 34a. When the indicator display bar 45 is moved to the right input box 39 by clicking the lower right corner region 18c after writing of the locus is completed, a character recognized from the locus written in the input locus display region 34a may be input into the blank input box 39. That is, a new character may be inserted in the middle of the character string.

In addition, as shown in FIG. 6, when the lower right corner region 18c of the input screen 7a is tapped without writing a character with the input pad 7 while the indicator display bar 45 is blinking in the blank input box 39, the indicator display bar 45 shown in FIG. 6 may move to the right input box 39 and the blank input box 39 may remain. That is, a space may be inserted in the middle of the character string.

Furthermore, as a method of inserting a space in the middle of the character string as shown in FIG. 6, it also may be possible to move the indicator display bar 45 to the input box 39 to be inserted by tapping the lower left corner region 18d, setting the ‘cursor mode’ by pressing the right button 8, operating the input pad 7 to move the cursor to the space insert indicator 44c in the auxiliary function panel 44, and tapping the input pad 7. Then, as shown in FIG. 6, the blank input box 39 within the character string may be formed and characters displayed in the input box 39 move rightward in a sequential manner.

When writing a character into the blank input box 39, the right button 8 may be pressed to return to the ‘character input mode’ and a character is written in handwriting. The character recognized by the handwritten locus may be displayed in the blank input box 39. In addition, by tapping the lower right corner region 18c and moving the indicator display bar 45 rightward, a space may be formed in the character string.

Furthermore, in order to change one of a plurality of characters input into the character display region 38, the blank input box 39 may be formed before or after a character to be changed, inputting a right character in the input box 39 by writing, and delete the wrong character therebefore or thereafter, as described above.

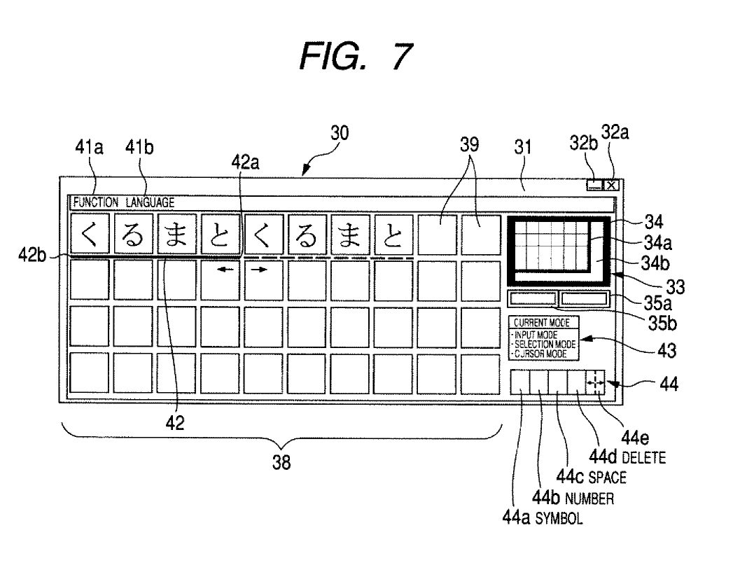

Next, as shown in FIG. 7, the position and length of the selection bar 42 which may determine a range of a character string to be converted can be changed. The procedures may be as follows. The right buttons maybe pressed to set the ‘cursor mode’. A finger touching the input screen 7a of the input pad 7 may move to locate a cursor at a right end 42a of the selection bar 42 and a drag operation may be performed on the input screen 7a by hand. That is, an operation of moving a finger rightward or leftward immediately after tapping may be performed. When the finger moves rightward, the right end 42a may extend in the right direction, such that a selection range formed by the selection bar 42 may extend rightward. When the finger which has dragged moves leftward, the right end 42a may move in the left direction, such that the selection range formed by the selection bar 42 may become narrow. Similarly, the position of a left end 42b may be changed by dragging the cursor in a state where the cursor is located at the left end 42b of the selection bar 42.

In addition, by moving the cursor under the character string in which the selection bar 42 is not displayed and moving the finger, which has dragged, rightward or leftward, the new selection bar 42 may be filled in the movement range.

At a point of time when the position of the selection bar 42 is changed and set, the right button 8 is pressed for switching to the ‘character input mode’.

Thus, in the handwriting tool 24, as shown in FIG. 4A, the locus based on an operation of the input pad 7 may be displayed and a character recognized from the locus may be displayed, and a character string may be converted. In the case of the conversion, proper words, such as ‘Chinese characters’, ‘phrase’, and ‘OKURIGANA’, may be selected. Therefore, the character string can be completed in a stage of the handwriting tool 24, and the completed character string may be transferred to the document tool board 50 by pressing the left button 9 after the completion. As a result, a sentence can be completed only by an operation of the handwriting tool 24 without a need to perform conversion, modification, and the like of a character by operating the document tool 25 after inputting the character in handwriting.

It should be understood by those skilled in the art that various modifications, combinations, sub-combinations and alternations may occur depending on design requirements and other factors insofar as they are within the scope of the appended claims of the equivalents thereof. Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. An input processing device comprising:
an input member having an input pad and a detecting section that detects a position where an indicator touches the input pad; and
a processing module that inputs a character or a figure on the basis of an input signal obtained from the input member,
wherein when a document tool and a handwriting tool are started by a processing operation of the processing module, a document tool board and a handwriting tool board are displayed on a display screen and an input locus display region where a locus drawn with the input pad is displayed and a character display region where a character or a symbol recognized from the locus is displayed are displayed, and
the character or the symbol displayed in the character display region is transferred to the document tool by a predetermined operation.

2. The input processing device according to claim 1,
wherein a plurality of characters recognized are displayed in a sequential manner as a character string in the character display region.

3. The input processing device according to claim 2,
wherein an indicator display indicating an input place of a character is made in the character display region, and
when a character or a symbol is drawn with the input pad and a predetermined operation is performed, the character or the symbol recognized from the locus drawn with the input pad is displayed in the place where the indicator display is shown and the indicator display moves by one character within the character display region to wait for input of a next character.

4. The input processing device according to claim 2,
wherein any of the plurality of characters displayed in the character display region may be deleted, or a character may be inserted within a character string displayed in the character display region.

5. The input processing device according to claim 1,
wherein when processing for converting the character displayed in the character display region is performed, a plurality of conversion candidates are displayed on the handwriting tool board and a character selected is displayed in the character display region when one of the conversion candidates is selected.

6. The input processing device according to claim 1, wherein when the character displayed in the character display region of the handwriting tool board is transferred to the document tool board, the character display region becomes blank so that a next character is input.

7. The input processing device according to claim 1,
wherein the document tool and the handwriting tool are executed by software installed in a control unit of a personal computer.
